(19) United States
(12) Patent Application Publication
(10) Pub. No.: US 2024/0310008 A1
(43) Pub. Date: Sep. 19, 2024

(54) METHODS AND SYSTEMS FOR SAFETY CONTROL OF GAS PRESSURE REGULATOR CABINET BASED ON REGULATORY IOT

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Lei ZHANG, Chengdu (CN); Zhubin CHENG, Chengdu (CN)

(73) Assignee: CHENGDU QINCHUAN IOT TECHNOLOGY CO., LTD., Chengdu (CN)

(21) Appl. No.: 18/670,691

(22) Filed: May 21, 2024

(30) Foreign Application Priority Data
Apr. 23, 2024 (CN) 202410490464.9

(51) Int. Cl. F17D 5/06; G01F 25/10

(52) U.S. Cl. CPC F17D 5/06; G01F 25/15

(57) ABSTRACT

The present disclosure provides a method and system for safety control of gas pressure regulator cabinet based on regulatory Internet of Things (IoT). The method may include: determining accident warning information based on light data, air data, and inspection information, sending the accident warning information to a government safety regulatory management platform, and obtaining feedback information from the government safety regulatory management platform; and determining a power use strategy based on power supply information, power storage module information, and power use information of at least one gas pressure regulator cabinet, and sending the power use strategy to the at least one gas pressure regulator cabinet. The system may include: a government safety regulatory service platform, a government safety regulatory management platform, a government safety regulatory sensor network platform, a gas company management platform, a gas company sensor network platform, and a gas device object platform.

### CROSS-REFERENCE TO RELATED APPLICATION

This application claims priority to Chinese application No. 202410490464.9 filed on Apr. 23, 2024, the entire content of which is incorporated herein by reference.

### TECHNICAL FIELD

The present disclosure relates to a field of gas pressure regulator cabinet control, and in particular, to a method and a system for safety control of gas pressure regulator cabinet based on regulatory Internet of Things (IoT).

### BACKGROUND

A gas pressure regulator cabinet is an important component of the gas transmission and distribution system, and a malfunction of the gas pressure regulator cabinet may cause significant inconvenience to the safety and daily life of residents. Currently, most gas companies require specialized personnel to be responsible for daily inspection, maintenance, and repair work of the gas pressure regulator cabinet, which take a long time to repair the gas pressure regulator cabinet when they fail.

Therefore, it is desired to propose a method and a system for safety control of gas pressure regulator cabinet based on Internet of Things to provide early warnings of potential failures of the gas pressure regulator cabinet, so as to make timely adjustments, and ensure a safety and a normal use of the gas pressure regulator cabinet as much as possible.

### SUMMARY

One or more embodiments of the present disclosure provide a method for safety control of gas pressure regulator cabinet based on regulatory Internet of Things (IoT). The method may be performed by a gas company management platform of a system for safety control of gas pressure regulator cabinet based on a regulatory IoT The method may include: determining accident warning information based on light data, air data, and inspection information, sending the accident warning information to a government safety regulatory management platform, and obtaining feedback information from the government safety regulatory management platform; and determining a power use strategy based on power supply information, power storage module information, and power use information of at least one gas pressure regulator cabinet, and sending the power use strategy to the at least one gas pressure regulator cabinet through a gas company sensor network platform.

One or more embodiments of the present disclosure provides a system for safety control of gas pressure regulator cabinet based on the regulatory IoT The system may include a government safety regulatory service platform, a government safety regulatory management platform, a government safety regulatory sensor network platform, a gas company management platform, a gas company sensor network platform, and a gas device object platform sequentially interacted with each other. The gas device object platform may include at least one gas pressure regulator cabinet. The gas company management platform may be configured to: determine accident warning information based on light data, air data, and inspection information, send the accident warning information to the government safety regulatory management platform, and obtain feedback information from the government safety regulatory management platform; and determine a power use strategy based on power supply information, power storage module information, and power use information of at least one gas pressure regulator cabinet, and send the power use strategy to the at least one gas pressure regulator cabinet through the gas company sensor network platform.

The beneficial effects brought about by the above-described content of the present disclosure include, but are not limited to: (1) by determining the accident warning information based on the light data, the air data, and the inspection information, early warning of possible accidents can be implemented, thereby enhancing the safety of the gas pressure regulator cabinet; (2) by determining the power use strategy based on the power supply information, the power storage module information, and the power use information of the gas pressure regulator cabinet, and sending the power use strategy to the gas pressure regulator cabinet, the electrical control of various functional modules in the gas pressure regulator cabinet can be achieved, so as to achieve an adaptive control of the gas pressure regulator cabinet, and enhance safety and functional efficiency; (3) by determining the first risk factor and the second risk factor based on the light data, the air data, and the environmental data, and further determining the accident warning information through a model based on the first risk factor and the second risk factor and other data, possible accidents and their corresponding probabilities can be accurately and effectively predicted, thereby facilitating targeted investigation and treatment and improving the safety of the gas pressure regulator cabinet.

### BRIEF DESCRIPTION OF THE DRAWINGS

The present disclosure is further illustrated by way of exemplary embodiments, which are described in detail by means of the accompanying drawings. These embodiments are not limiting, and in these embodiments, the same numbering denotes the same structure, wherein:

FIG. 1 is a diagram illustrating an exemplary structure of a system for safety control of a gas pressure regulator cabinet based on regulatory Internet of Things (IoT) according to some embodiments of the present disclosure;

FIG. 2 is a flowchart illustrating an exemplary process for safety control of a gas pressure regulator cabinet based on regulatory IoT according to some embodiments of the present disclosure;

FIG. 3 is a schematic diagram illustrating an exemplary risk factor determination model according to some embodiments of the present disclosure; and

FIG. 4 is a schematic diagram illustrating an exemplary prediction model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for those skilled in the art to apply the present disclosure to other similar scenarios in accordance with these drawings without creative labor. Unless obviously obtained from the context or the context illustrates otherwise, the same numeral in the drawings refers to the same structure or operation.

It may be understood that the terms “system,” “device,” “unit,” and/or “module” as used herein is a way to distinguish between different components, elements, parts, sections, or assemblies at different levels. However, the words may be replaced by other expressions if other words accomplish the same purpose.

As shown in the present disclosure and in the claims, unless the context clearly suggests an exception, the words “a,” “one,” “an,” and/or “the” do not refer specifically to the singular, but may also include the plural. Generally, the terms “including” and “comprising” suggest only the inclusion of clearly identified operations and elements. In general, the terms “including” and “comprising” only suggest the inclusion of explicitly identified steps and elements that do not constitute an exclusive list, and the method or apparatus may also include other operations or elements.

Flowcharts are used in the present disclosure to illustrate operations performed by a system in accordance with embodiments of the present disclosure. It may be appreciated that the preceding or following operations are not necessarily performed in an exact sequence. Instead, the operations may be processed in reversely order or simultaneously. Also, it may be possible to add other operations to these processes or remove an operation or operations from them.

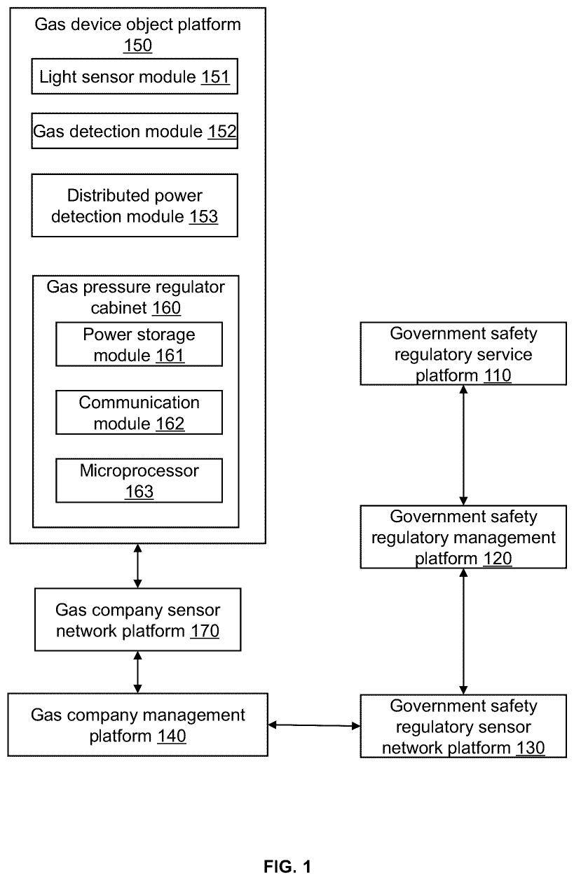

FIG. 1 is diagram illustrating an exemplary structure of a system for safety control of a gas pressure regulator cabinet based on regulatory Internet of Things (IoT) according to some embodiments of the present disclosure.

As shown in FIG. 1, the system for safety control of gas pressure regulator cabinet based on the regulatory IoT may include a government safety regulatory service platform 110, a government safety regulatory management platform 120, a government safety regulatory sensor network platform 130, a gas company management platform 140, a gas device object platform 150, and a gas company sensor network platform 170 sequentially interacted with each other.

The government safety regulatory service platform 110 may be a platform for providing a safety regulatory service for a government. The government safety regulatory management platform 120 may be a platform for performing safety regulatory and a management of safety regulatory related information. The government safety regulatory sensor network platform 130 may be a functional platform for the government to obtain the safety regulatory related information and transmit a government safety regulatory instruction. The gas company management platform 140 may be a platform for coordinating connection and collaboration between various functional platforms of the company, gathering the information, and providing a perception management and a control management functions. The gas device object platform 150 may be a functional platform for generating perception information and executing control information. In some embodiments, the gas company management platform 140 and the gas device object platform 150 may perform an information interaction with through the gas company sensor network platform 170. The gas company sensor network platform 170 may be a functional platform for managing a sensor communication.

In some embodiments, the gas company management platform 140 may interact with at least one gas pressure regulator cabinet 160 in the gas device object platform 150 through the gas company sensor network platform 170. The gas pressure regulator cabinet 160 may be a regulating device made for features of a gas usage of gas, the gas pressure regulator cabinet 160 may have a plurality of functions such as a filtering, a pressure regulating, a metering, or the like.

In some embodiments, the gas company management platform 140 may be configured to determine accident warning information based on light data, air data, and inspection information, send the accident warning information to the government safety regulatory management platform 120, and obtain feedback information from the government safety regulatory management platform 120; determine a power use strategy based on power supply information, power storage module information, and power use information of at least one gas pressure regulator cabinet 160, and send the power use strategy to the at least one gas pressure regulator cabinet 160 through a gas company sensor network platform 170.

In some embodiments, the gas company management platform 140 may be further configured to determine a weatherability of the at least one gas pressure regulator cabinet 160 to environment based on the inspection information; and determine the accident warning information based on the light data, the air data, and the weatherability of the at least one gas pressure regulator cabinet to the environment.

In some embodiments, the gas company management platform 140 may be further configured to determine a first risk factor and a second risk factor based on the light data, the air data, and environmental data; and determine the accident warning information based on the first risk factor, the second risk factor, and the weatherability of the at least one gas pressure regulator cabinet 160 to the environment.

In some embodiments, the gas company management platform 140 may be further configured to determine a must-be-opened module set based on a module functional importance and the power supply information; and determine the power use strategy based on the power use information of the at least one gas pressure regulator cabinet 160, the must-be-opened module set, the power storage module information, and the module functional importance.

More descriptions of the gas company management platform 140 may be found in the following content.

In some embodiments, the gas device object platform 150 may include a light sensor module 151, a gas detection module 152, a distributed power detection module 153, and at least one gas pressure regulator cabinet 160. The light sensor module 151 may be configured to obtain the light data. The gas detection module 152 may be configured to obtain the air data. The distributed power detection module 153 may be configured to detect a power condition.

In some embodiments, at least a portion of each of the light sensor module 151, the gas detection module 152, and the distributed power detection module 153 may be disposed in the at least one gas pressure regulator cabinet 160. In some embodiments, the distributed power detection module 153 may be disposed in a plurality of functional modules of the gas pressure regulator cabinet 160 for detecting the power condition of each functional module.

In some embodiments, the at least one gas pressure regulator cabinet 160 may include the plurality of functional modules, and the plurality of functional modules may include a power storage module 161, a communication module 162, a microprocessor 163, or the like. The power storage module 161 may be configured to store power, and the power storage module 161 may automatically start and supply power in an event of a sudden power failure. The communication module 162 may be configured for information transmission between the gas pressure regulator cabinet 160 and the gas company management platform 140, and may also be configured for information transmission between the plurality of functional modules of the gas pressure regulator cabinet 160. For example, the power storage module 161 may realize the information transmission with the microprocessor 163 through the communication module 162.

In some embodiments, the microprocessor 163 may be configured to obtain the light data, the air data, the power storage module information, and the power use information of the at least one gas pressure regulator cabinet 160 through the communication module 162, and transmit the light data, the air data, and the power use information of the at least one gas pressure regulator cabinet 160 to the gas company management platform 140 through the gas company sensor network platform 170.

In some embodiments, the microprocessor 163 of the gas pressure regulator cabinet 160 may be configured to obtain the power use strategy from the gas company management platform 140 through the gas company sensor network platform 170. The at least one gas pressure regulator cabinet 160 may, in response to a power failure of a power supply line, switch to the power storage module 161 for power supply based on the power use strategy, and shut down or restart at least one of the plurality of functional modules. More descriptions of the power use strategy may be found in the following content.

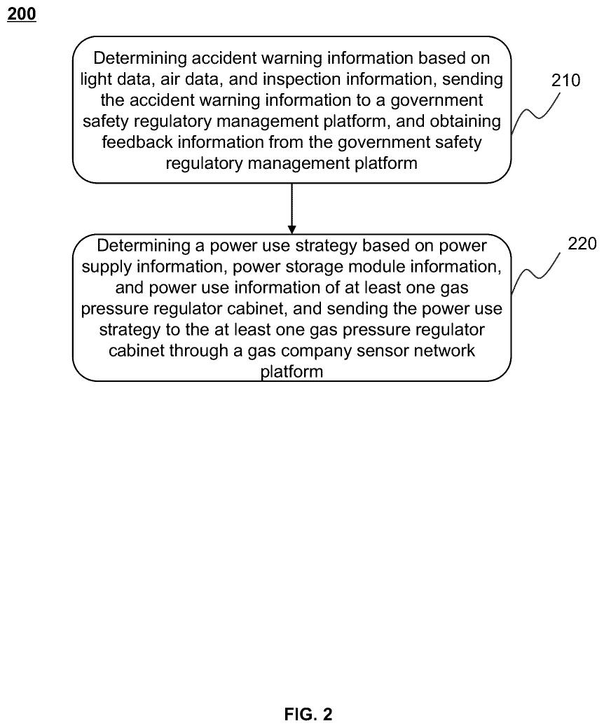

FIG. 2 is a flowchart illustrating an exemplary process for safety control of a gas pressure regulator cabinet based on regulatory IoT according to some embodiments of the present disclosure. As shown in FIG. 2, a process 200 may include the following operations. In some embodiments, the process 200 may be performed by the gas company management platform 140 of the system for safety control of the gas pressure regulator cabinet based on the regulatory IoT.

In 210, accident warning information may be determined based on light data, air data, and inspection information, the accident warning information may be sent to the government safety regulatory management platform 120, and feedback information may be obtained from the government safety regulatory management platform 120.

The light data refers to data related to a light around the gas pressure regulator cabinet 160. For example, the light data may include a light intensity, a brightness, or the like. The light data may be collected by the light sensor module 151.

The air data refers to data related to an air around the gas pressure regulator cabinet 160. For example, the air data may include a gas conductivity, a gas concentration, a humidity, a smoke concentration, a water vapor concentration, or the like. The air data may be collected by the gas detection module 152.

The inspection information refers to information recorded during an inspection. In some embodiments, the inspection information may include whether an abnormality occurs in the gas pressure regulator cabinet 160, a weather situation during the inspection, or the like. The inspection information may be obtained based on the gas company management platform 140.

The accident warning information refers to warning information related to various accidents that occur in the gas pressure regulator cabinet 160.

In some embodiments, the accident warning information may include possible accident and a corresponding probability of the gas pressure regulator cabinet 160. The possible accident may include one or more of a gas pressure regulator cabinet power leakage, a gas pressure regulator cabinet gas leakage, and an accumulation of water or snow.

The gas company management platform 140 may determine the accident warning information based on various ways. For example, the gas company management platform 140 may construct a to-be-matched vector based on the light data, the air data, and the inspection information, and determine the accident warning information based on a retrieval result of the to-be-matched vector in a vector database.

The vector database may include a plurality of reference vectors and accident information corresponding to each of the reference vectors. The reference vectors may be constructed based on the light data, the air data, and the inspection information during historical inspections in historical data by means of feature extraction and classification. The accident information may include types of accidents that actually occurred and their corresponding occurrence frequencies.

The gas company management platform 140 may match the to-be-matched vector with the reference vectors, select the accident information corresponding to the reference vector whose matching degree satisfies a preset matching degree condition, as a possible accident, and determine a normalization of the matching degree as the probability corresponding to the possible accident, thus determining the accident warning information. The preset matching degree condition may be set as desired, such as a vector distance between the to-be-matched vector and the reference vector is minimized.

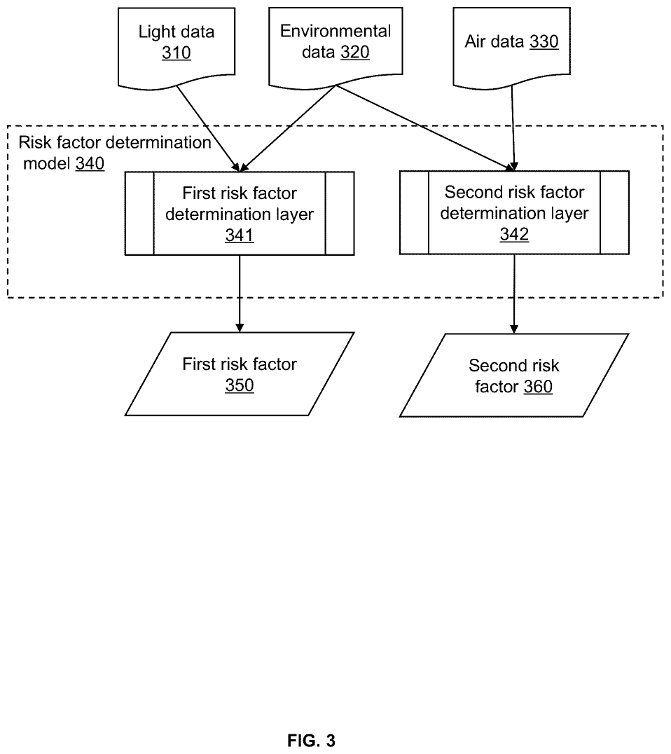

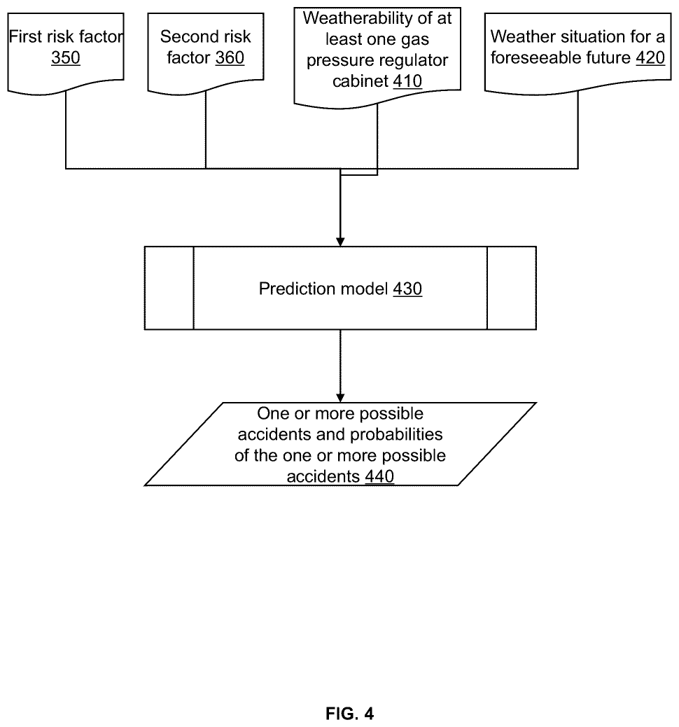

The accident warning information may also be determined in other ways, more contents of determining the accident warning information may be found in FIG. 3, FIG. 4, and the related descriptions.

The feedback information refers to a feedback from the government safety regulatory management platform 120 on the accident warning information. The feedback information may include a priority of the accident warning information, a recommended resolution time of the accident warning information, or the like. For example, the feedback information may include a request for an early, extended, or immediate resolution, and the feedback information may also address how to resolve the accident warning information, and solve the accident warning information by which party, or the like. The feedback information may be obtained through the government safety regulatory management platform 120.

In some embodiments, the feedback information may be determined by the government safety regulatory management platform 120 based on the accident warning information within a preset time. In some embodiments, the gas company management platform 140 may determine the priority of the accident warning information, the recommended resolution time of the accident warning information or the like. based on the accident warning information within a preset time obtained by the government safety regulatory management platform 120, and combining an accident hazard level.

In some embodiments, the priority of the accident warning information may be determined by scoring. For example, the gas company management platform 140 may score the accident warning information, sort the accident warning information according to the scores in a descending order, and determine the priorities based on the sorted scores. For example, the gas company management platform 140 may prioritize the accident warning information with the top 5% score as a first priority, the accident warning information with a 5-25% score as a second priority, or the like. In some embodiments, the score may be positively correlated to a probability of the accident occurrence and the accident hazard level. The probability of the accident occurrence may be the probability corresponding to the accident that may occur in the gas pressure regulator cabinet 160 in the accident warning information, referring to the relevant instructions for the accident warning information. The accident hazard level refers to a grading based on the degree of hazard of the accident, and the accident hazard level may be preset empirically.

In some embodiments, the recommended resolution time of the accident warning information may be determined based on the priority of the accident warning information. The gas company management platform 140 may determine the recommended resolution time of the accident warning information by checking a preset correspondence table between the priority of the accident warning information and the recommended resolution time of the accident warning information. The correspondence table may be set manually based on experience. For example, if the first priority accident warning information needs to be resolved within 3 days, the recommended resolution time may be within 3 days.

In 220, a power use strategy may be determined based on power supply information, power storage module information, and power use information of the at least one gas pressure regulator cabinet 160, and the power use strategy may be sent to the at least one gas pressure regulator cabinet 160 through the gas company sensor network platform 170.

The power supply information refers to information related to a power supply of the gas pressure regulator cabinet 160. For example, the power supply information may be that there is a power outage for a certain period of time, or the like. The power supply information may be obtained based on the government safety regulatory service platform 110.

The power storage module information refers to information related to the power storage module 161. The power storage module information may include at least one of a current power storage, a power storage capacity, a charging power, a discharging power, or the like. The power storage module information may be obtained based on the distributed power detection module 153.

The power use information of the gas pressure regulator cabinet 160 refers to information related to the power use of the gas pressure regulator cabinet 160. For example, the power use information may be a power consumption, a current power consumption, or the like. The power use information of the gas pressure regulator cabinet 160 may be obtained based on the distributed power detection module 153.

The power use strategy refers to when each of a plurality of functional modules of the gas pressure regulator cabinet 160 starts using power and stop using power.

In some embodiments, the power use strategy may include opening and closing situations and opening and closing time points of the plurality of functional modules of the gas pressure regulator cabinet 160, or the like.

The gas company management platform 140 may determine the power use strategy based on a variety of feasible ways, e.g., the power use strategy may be manually preset based on experience. More descriptions of how to determine the power use strategy may be found in FIG. 4 and the related descriptions.

In some embodiments, the gas company management platform 140 may generate a corresponding power use instruction based on the power use strategy. The power use instruction refers to an instruction generated based on the power use strategy to control the gas pressure regulator cabinet 160 to perform a corresponding operation. The power use instruction may include switching to the power storage module 161 for power supply, shutting down or restarting a portion of the functional modules of the gas pressure regulator cabinet 160, or the like. Exemplarily, the power use strategy may include that the power storage module 161 and the communication module 162 of the gas pressure regulator cabinet 160 starting to use power at a same time T1. The power storage module 161 may be powered off at a time T2. The communication module 162 may be powered down at a time T3. The gas company management platform 140 may generate the power use instruction for supplying power to the power storage module 161 and the communication module 162 at the time T1 or before the time T1, and may send the power use instruction to the power storage module 161 and the communication module 162. The gas company management platform 140 may generate a power use instruction for disconnecting power to the power storage module 161 at the time T2 or before the time T2 and send the power use instruction to the power storage module 161. The gas company management platform 140 may generate a power use instruction for disconnecting power to the communication module 162 and send power use instruction to the communication module 162 at the time T3 or before the time T3.

In some embodiments of the present disclosure, the gas company management platform 140 may determine the accident warning information based on the light data, the air data, and the inspection data, so as to perform an early warning for the possible accidents and improve a safety of the gas pressure regulator cabinet. The gas company management platform 140 may determine the power use strategy based on the power supply information, the power storage module information, and the power use information of the gas pressure regulator cabinet, and the gas company management platform 140 may further send the power use instruction generated based on the power use strategy to the gas pressure regulator cabinet, so as to enable a power consumption control of each functional module in the gas pressure regulator cabinet, achieve an adaptive control of the gas pressure regulator cabinet, and improve safety and functional efficiency.

In some embodiments, the gas company management platform 140 may determine a weatherability of the at least one gas pressure regulator cabinet 160 to environment based on the inspection information; and determine the accident warning information based on the light data, the air data, and the weatherability of the at least one gas pressure regulator cabinet 160 to the environment.

The weatherability of the gas pressure regulator cabinet 160 to the environment refers to an ability of the gas pressure regulator cabinet 160 to resist environmental changes. For example, the weatherability of the gas pressure regulator cabinet 160 may include a maximum temperature that a metal component of the gas pressure regulator cabinet 160 is able to withstand or an ability of the gas pressure regulator cabinet 160 to withstand a salt corrosion, or the like. The weatherability of the gas pressure regulator cabinet 160 to the environment may include the weatherabilities of the parts of the gas pressure regulator cabinet 160 to the environment.

In some embodiments, the gas company management platform 140 may determine the weatherability of the gas pressure regulator cabinet 160 to the environment based on a first preset table. The first preset table may contain a relationship between the weatherability of each component of the gas pressure regulator cabinet 160 to the environment and the inspection information, and the first preset table may be manually preset. The gas company management platform 140 may query the first preset table to determine the weatherability of each component of the gas pressure regulator cabinet 160 to the environment based on current inspection information of each component of the gas pressure regulator cabinet 160.

In some embodiments, the gas company management platform 140 may determine, based on the inspection information, the weatherability of the at least one gas pressure regulator cabinet 160 to the environment through a preset algorithm. In some embodiments, the gas company management platform 140 may determine, through a frequent item algorithm, the weatherability of the at least one gas pressure regulator cabinet 160 to the environment.

A logic of the frequent item algorithm may be counting the most frequently occurring data in a dataset and use the most frequently occurring data as target data. In some embodiments, the gas company management platform 140 may count, based on historical inspection information, an average or a mode of environmental indicators corresponding to a component of the gas pressure regulator cabinet 160 for a preset period of time before the occurrence of the same malfunction. The environmental indicators may include a weather, a temperature, a humidity, a dust content, or the like. The gas company management platform 140 may represent the statistical result with a data sequence set. The data sequence set may include sequences of the environmental indicators corresponding to different inspection information for the preset period of time before the occurrence of the same malfunction in the historical inspection information.

For example, in the historical inspection information, there may be two pieces of the inspection information indicating the occurrence of a malfunction x in component A, namely A1 and A2. In the preset period, for example, a week of time before the malfunction x occurs, the data sequence set corresponding to A1 may include a temperature sequence t₁ (0, −1, −2, −5, −2, 0, −4), a weather sequence w1 (snow, sleet, rain, snow, snow, snow, sleet), and a dust content sequence d1 (85, 88, 89, 90, 91, 92, 95). An elemental average value of the temperature sequence may be −2° C., an elemental mode of the weather sequence may be snow, and an elemental average value of the dust content sequence may be 90. The data sequence set corresponding to A2 may include a temperature sequence t₂ (−5, −3, −2, −5, −2, 0, −4), a weather sequence w₂ (rain and snow, rain and snow, snow, snow, snow, snow, rain and snow), and a dust content sequence d₂ (79, 78, 79, 70, 69, 72, 66). The elemental average value of the temperature sequence may be −3° C., the elemental mode of the weather sequence may be snow, and the elemental average value of the dust content sequence may be 73.29.

In some embodiments, the gas company management platform 140 may preset different deviation ranges for each environmental indicator. The deviation range refers to a range that is satisfied by a difference of the environmental indicators when two environmental indicators are considered to be the same. For example, the gas company management platform 140 may set a temperature deviation range to 2° C., and a dust content deviation range to 10. Then, in the above example, as the difference of the average values of the temperatures corresponding to A1 and A2 is smaller than 2° C., the temperatures may be considered to be the same. As the difference in the average values of the dust contents is greater than 10, the dust contents may be considered to be different.

In some embodiments, the gas company management platform 140 may count the same values as frequent items based on the deviation ranges and the data sequence set. For example, for the inspection information A1 and A2 corresponding to the component A in the above example, as the difference between the temperature average values is within the temperature deviation range and the model of the weather is the same, it may be considered that the temperatures and weathers are the same, and the dust content is different. Therefore, the gas company management platform 140 may determine the frequent item of A1 and A2 as (−2.5, snow). −2.5 may be an average of the temperature averages of A1 and A2.

In some embodiments, the gas company management platform 140 may determine the weatherability of a component to the environment by checking a second preset table based on elements of the frequent item. The second preset table may contain a relationship between the various environmental indicators corresponding to the component and the weatherability of the component, and may be preset manually.

In some embodiments of the present disclosure, the preset algorithm may enable a fast and effective determination of the weatherability of each component of the gas pressure regulator cabinet to the environment on the basis of the inspection information, and the accuracy of the results may be high.

In some embodiments, the gas company management platform 140 may determine the accident warning information based on the light data, the air data, and the weatherability of each component of the at least one gas pressure regulator cabinet 160 to the environment in a variety of feasible ways. For example, the gas company management platform 140 may construct to-be-matched vectors based on the light data, the air data, and the weatherability of each component to the environment, match the to-be-matched vectors in a reference vector database, and select the accident warning information corresponding to the reference vector whose similarity satisfies a preset condition as the current accident warning information. The reference vector database may include a plurality of reference vectors and the accident information corresponding to the reference vectors. The reference vectors may be constructed based on the light data, the air data, and the weatherability of each component in the historical data. The preset condition may be set as appropriate. For example, the preset condition may be with the maximum similarity, or the similarity being greater than a threshold, or the like.

In some embodiments, the accident warning information may be related to environmental data. In some embodiments, the gas company management platform 140 may determine a first risk factor and a second risk factor based on the light data, the air data, and the environmental data, and determine the accident warning information based on the first risk factor, the second risk factor, and the weatherability of the at least one gas pressure regulator cabinet 160 to the environment.

The environmental data may include the temperature, the humidity, or the like. of the environment in which the gas pressure regulator cabinet 160 is located. In some embodiments, the environmental data may be obtained based on the government safety regulatory sensor network platform 130. For example, the gas company management platform 140 may obtain information related to government regulation, including the environmental data, from the government safety regulatory management platform 120 based on the government safety regulatory sensor network platform 130. In some embodiments, the gas company management platform 140 may obtain the environmental data from a plurality of sensors (e.g., a temperature sensor, a humidity sensor, or the like.) disposed inside and outside of the gas pressure regulator cabinet 160 based on the gas company sensor network platform 170.

The first risk factor and the second risk factor may reflect a risk situation of the at least one gas pressure regulator cabinet 160. The first risk factor refers to a parameter indicating the risk situation associated with the gas pressure regulator cabinet 160 itself. The risk situation refers to an impact of environmental changes on the gas pressure regulator cabinet 160 itself, for example, when a continuous rainfall or a snow melting occurs, there may be a situation in which rain, snow, or silt enters the gas pressure regulator cabinet 160.

The first risk factor may be expressed as a boolean value of 0-1. For example, when the gas pressure regulator cabinet 160 is intact and there is no risk, the first risk factor may be 1; conversely, when an intactness of the gas pressure regulator cabinet 160 is destroyed, the first risk factor may be 0. The gas company management platform 140 may determine whether the gas pressure regulator cabinet is intact through a variety of indicators. For example, the gas company management platform 140 may determine whether the gas pressure regulator cabinet is intact based on whether the gas pressure regulator cabinet 160 is sealed, watertight, and moisture resistant, or the like.

The second risk factor refers to a parameter that indicates the risk situation of the functional modules inside the gas pressure regulator cabinet 160. The risk situation of the functional module may be a regulator attachment that generates leaks, gas leaks, or the like. due to corrosion. The second risk factor may be expressed as a numerical value, e.g., it may be expressed as a numerical value within a range of 0-100, and the greater the value, the greater the risk of the corresponding functional module.

In some embodiments, the gas company management platform 140 may determine the first risk factor and the second risk factor based on the light data, the air data, and the environmental data by vector matching.

In some embodiments, the gas company management platform 140 may construct the to-be-matched vector based on the light data, the air data, and the environmental data. The gas company management platform 140 may determine a plurality of cluster centers based on historical light data, historical air data, historical environmental data, historical first risk factors and historical second risk factors by clustering (e.g., processes such as K-Means clustering), and take the light data, air data, and environmental data corresponding to the cluster centers as the reference vector.

In some embodiments, the gas company management platform 140 may determine the first risk factor and the second risk factor based on distances between the to-be-matched vectors and the cluster centers. The processes for calculating the distances may include, but are not limited to, Euclidean distances, or the like. For example, the gas company management platform 140 may take the reference vector corresponding to the clustering center with the smallest distance between the to-be-matched vectors as a target vector, take the first risk factor and the second risk factor corresponding to the target vector as a current first risk factor and a current second risk factor.

In some embodiments, the gas company management platform 140 may determine the accident warning information by checking a third preset table based on the current first risk factor, the current second risk factor, and the weatherability of each component to the environment. The third preset table may include a correspondence between the first risk factor, the second risk factor, the weatherability of each component to the environment, and the accident warning information, and may be preset manually.

In some embodiments, the gas company management platform 140 may determine the first risk factor and the second risk factor based on the light data, the air data, and the environmental data through a risk factor determination model.

The risk factor determination model may be a machine learning model that is used to determine the first risk factor and the second risk factor. FIG. 3 is a schematic diagram illustrating an exemplary risk factor determination model according to some embodiments of the present disclosure. The risk factor determination model 340 may be a multi-layer structure, for example, the risk factor determination model 340 may include a first risk factor determination layer 341 and a second risk factor determination layer 342.

As shown in FIG. 3, an input of the first risk factor determination layer 341 may include light data 310 and environmental data 320, and an output may be a first risk factor 350. An input of the second risk factor determination layer 342 may include environmental data 320 and air data 330, and an output may be a second risk factor 360. More descriptions of the light data and the air data may be found in FIG. 1 and the related descriptions. More descriptions of the environmental data may be found in previous contents.

In some embodiments, the gas company management platform 140 may obtain a trained risk factor determination model based on a plurality of first samples with first labels by joint training.

The first samples may include sample light data, sample air data, and sample environmental data. The first samples may be obtained based on historical data. The first labels may include sample first risk factors and sample second risk factors corresponding to the first samples under a first sample condition. The sample first risk factors and the sample second risk factors may be determined based on an actual situation of the gas pressure regulator cabinet 160. The gas company management platform 140 may determine the sample first risk factors based on whether the actual gas pressure regulator cabinet 160 is intact. The gas company management platform 140 may determine the sample second risk factors by checking a fourth preset table based on a frequency of occurrence of malfunctions of the functional modules of the gas pressure regulator cabinet 160 in the actual situation. The fourth preset table may include a correspondence between the frequency of occurrence of malfunctions of various functional modules of various gas pressure regulator cabinets and the second risk factors, which is preset manually.

In some embodiments of the present disclosure, the first risk factor and the second risk factor may be quickly and accurately determined based on the light data, the air data, and the environmental data by the risk factor determination model.

In some embodiments, the accident warning information may include the accident warning information for a foreseeable future. The accident warning information for a foreseeable future may be related to a weather situation for the foreseeable future. In some embodiments, the gas company management platform 140 may determine the accident warning information based on the first risk factor, the second risk factor, the weatherability of the at least one gas pressure regulator cabinet 160 to the environment, and the weather situation for the foreseeable future.

The accident warning information for the foreseeable future refers to predicted accidents that occur in the gas pressure regulator cabinet 160 in a preset foreseeable future and corresponding probabilities. The accident warning information for the foreseeable future may be related to the weather situation for the foreseeable future, which is obtained based on the government safety regulatory sensor network platform 130.

In some embodiments, the gas company management platform 140 may determine the accident warning information based on the first risk factor, the second risk factor, the weatherability of the gas pressure regulator cabinet 160 to the environment, and the weather situation in the foreseeable future by checking a fifth preset table. The fifth preset table may include a correspondence between the first risk factor, the second risk factor, the weatherability of the gas pressure regulator cabinet 160 to the environment, the weather situation in the foreseeable future and the accident warning information, which is preset manually.

In some embodiments, the gas company management platform 140 may determine, based on the first risk factor, the second risk factor, the weatherability of the at least one gas pressure regulator cabinet 160 to the environment, and the weather situation for the foreseeable future, the accident warning information through a prediction model.

The prediction model may be a machine learning model. FIG. 4 is a schematic diagram illustrating an exemplary prediction model according to some embodiments of the present disclosure. As shown in FIG. 4, an input of a prediction model 430 may include the first risk factor 350, the second risk factor 360, a weatherability 410 of the at least one gas pressure regulator cabinet 160 to environment and a weather situation 420 for a foreseeable future; an output may be one or more possible accidents and probabilities of the one or more possible accidents 440 (i.e., accident warning information). The first risk factor 350 and the second risk factor 360 may be output results of the risk factor determination model 340.

In some embodiments, the gas company management platform 140 may train the prediction model based on a plurality of second samples with second labels. The second samples may include sample first risk factors, sample second risk factors, weatherabilities of sample gas pressure regulator cabinets to the environment, and weather situations during a first historical period of time. The second samples may be obtained based on historical data. The second labels may be actual accidents and their frequency of occurrence during a second historical period corresponding to the second samples under a second sample condition, and the probability may be determined by conversion based on the frequency. The first historical period of time may be the same historical period of time as the second historical period of time.

For example, when the frequency of occurrence of an accident is not less than a standard frequency, the probability of occurrence of the accident may be determined by the following formula: Probability of occurrence of accident=(Frequency of occurrence of accident−Standard frequency)*Standard accident probability/Standard frequency. The standard frequency and the standard accident probability refer to preset frequency and probability of occurrence of the accident, which are preset manually or determined according to factory settings of the gas pressure regulator cabinet.

Exemplarily, the probability of occurrence of an accident may be considered to be the standard frequency of the accident when the frequency of occurrence of the accident is equal to the standard frequency.

In some embodiments of the present disclosure, the prediction model may quickly and accurately determine the accident warning information based on the first risk factor, the second risk factor, the weatherability of the at least one gas pressure regulator cabinet to the environment, and the weather situations in the foreseeable future.

In some embodiments of the present disclosure, the first risk factor and the second risk factor may be determined through the light data, the air data, and the environmental data, and the accident warning information may be further determined through modeling based on data such as the first risk factor and the second risk factor. It may be possible to accurately and effectively predict possible accidents and corresponding probabilities, thereby facilitating a targeted investigation and treatment and improving the safety of the gas pressure regulator cabinet.

In some embodiments, the gas company management platform 140 may determine a must-be-opened module set based on a module functional importance and power supply information; determine a power use strategy based on power use information of the at least one gas pressure regulator cabinet 160, the must-be-opened module set, power storage module information, and the module functional importance. More descriptions of the power supply information, the power use information, the power storage module information, and the power use strategy may be found in FIG. 2 and the related descriptions.

The module functional importance refers to a degree of importance of the functional module and the corresponding function to the gas pressure regulator cabinet 160. In some embodiments, the module functional importance may be preset manually.

The must-be-opened module set refers to a one or more functional modules that must be opened by the gas pressure regulator cabinet 160 when a power failure occurs.

In some embodiments, the gas company management platform 140 may determine the must-be-opened module by evaluating a plurality of functional modules based on the module functional importance and the power supply information; and generate the must-be-opened module set based on the must-be-opened module.

Exemplarily, the gas company management platform 140 may add a functional module to the must-be-opened module set when the module functional importance corresponding to the functional module is greater than a preset importance threshold. The preset importance threshold refers to a minimum module functional importance that needs to be met for the module to remain on during a power failure, which is adjusted based on the actual situation and the power supply information.

For example, when the power failure lasts for an extended period, the gas company management platform 140 may enhance the preset importance threshold to prioritize an operation of the most critical functional modules; when the power failure is shorter, the gas company management platform 140 may lower the preset importance threshold to allow the essential functional modules to operate more efficiently.

In some embodiments, the preset importance threshold may also be associated with the second risk factor. When the second risk factor is greater than a preset risk threshold, it indicates that the functional module is extremely risky, and at this point, for safety, the preset importance threshold may take a preset maximum value, i.e., only the most basic functional modules are retained. The preset risk threshold may be preset as needed.

In some embodiments of the present disclosure, a risk situation of the functional module may be obtained based on the second risk factor, and the second risk factor may be used as a consideration for determining the must-be-opened module. In this way, the safety of the gas pressure regulator cabinet may be greatly enhanced.

In some embodiments, the gas company management platform 140 may determine the power use strategy based on the module functional importance by checking a sixth preset table. The sixth preset table may contain a correspondence between the power use information of the at least one gas pressure regulator cabinet 160, the must-be-opened module set, the power storage module information, the module functional importance, and the power use strategy. The sixth preset table may be preset manually.

In some embodiments, the gas company management platform 140 may determine the power use strategy based on the power use information of the at least one gas pressure regulator cabinet 160, the must-be-opened module set, the power storage module information, and the module functional importance through a power use strategy determination model.

The power use strategy determination model may be a machine learning model, e.g., a Graph Neural Network (GNN) model. An input of the power use strategy determination model may include a modular diagram, and output may include power use periods of time for various nodes of the modular diagram.

The modular diagram refers to a diagram generated based on the functional modules of the gas pressure regulator cabinet 160. The modular diagram may include a plurality of nodes and a plurality of edges. In the modular diagram, the nodes may be functional modules of the gas pressure regulator cabinet 160. Types of the nodes may include other module nodes, a power storage module node, or the like. The other module nodes may correspond to the functional modules of the gas pressure regulator cabinet 160 other than the power storage module 161. The power storage module node may correspond to the power storage module 161.

Node features included in different types of nodes may be different. For example, the node features of the other module nodes may include power use information for each functional module of the gas pressure regulator cabinet 160, the must-be-opened module, a module selected to be open, the module functional importance, or the like. The node features of the power storage module node may include a battery power, the power storage module information, or the like.

In some embodiments, the power use period of each node output by the power use strategy determination model may correspond to a power use period of each functional module of the gas pressure regulator cabinet 160, i.e., the power use strategy.

The plurality of nodes may be connected by edges, and attributes of the edges may reflect relationships between the nodes. In some embodiments, when there is an associated relationship between two nodes (e.g., a communication pipeline, a power supply relationship, or the like.), the two nodes may be connected by an edge. In some embodiments, the attributes of the edges connecting the nodes may include a communication relationship, a power supply relationship, or the like. For example, there may be an edge between the functional module that uses power and the power storage module 161. The edge feature may include, for example, a communication importance degree, which is used to indicate the importance of the information transfer between the two functional modules to the gas pressure regulator cabinet 160. The communication importance degree may be manually preset.

In some embodiments, the gas company management platform 140 may train the power use strategy determination model based on a sample of historical modular diagram with a training label. The training label may be obtained by manual labeling based on the period of time of power use in the historical modular diagram when there are no accidents and the nodes are operating normally.

In some embodiments of the present disclosure, the power use strategy determination model may enable a quick and accurate determination of when each of the plurality of functional modules starts using power and stops using power, based on the modular diagram.

In some embodiments, the gas company management platform 140 may determine a necessary module based on the power use strategy and the must-be-opened module set; and in response to a presence of the accident warning information, supply power to the necessary module only.

The necessary module may be a functional module that must be guaranteed to operate. The gas company management platform 140 may determine one or more functional modules in the must-be-opened module set that satisfy a preset condition as the necessary modules. The preset condition may include the module functional importance being greater than a preset necessary threshold, or the module does not have a malfunction, or the like.

In some embodiments, the accident warning information may indicate that the accident happens to the at least one gas pressure regulator cabinet 160. In such cases, the power supply should be retained only to the necessary module of the gas pressure regulator cabinet 160, so as to ensure the normal operation of the essential functions only, guarantee safety, facilitate troubleshooting, improve power supply safety, and ensure the functionality of the gas pressure regulator cabinet.

The basic concepts have been described above, and it may be apparent to those skilled in the art that the foregoing detailed disclosure serves only as an example and does not constitute a limitation of the present disclosure. While not expressly stated herein, those skilled in the art may make various modifications, improvements, and amendments to the present disclosure. Those types of modifications, improvements, and amendments are suggested in the present disclosure, so they remain within the spirit and scope of the exemplary embodiments of the present disclosure.

Also, the present disclosure uses specific words to describe embodiments of the present disclosure. Such as “an embodiment,” “one embodiment,” and/or “some embodiments” means a feature, structure, or characteristic associated with at least one embodiment of the present disclosure. Accordingly, it may be emphasized and noted that the “one embodiment” or “an embodiment” or “an alternative embodiment” in different places in the present disclosure do not necessarily refer to the same embodiment. In addition, certain features, structures, or characteristics in one or more embodiments of the present disclosure may be suitably combined.

Furthermore, unless expressly stated in the claims, the order of the processing elements and sequences described herein, the use of numerical letters, or the use of other names are not intended to qualify the order of the processes and methods of the present disclosure. While some embodiments of the present disclosure that are currently considered useful are discussed in the foregoing disclosure by way of various examples, it may be appreciated that such details serve only illustrative purposes, and that additional claims are not limited to the disclosed embodiments, rather, the claims are intended to cover all amendments and equivalent combinations that are consistent with the substance and scope of the embodiments of the present disclosure. For example, although the implementation of various components described above may be embodied in a hardware device, it may also be implemented as a software only solution, e.g., an installation on an existing server or mobile device.

Similarly, it may be noted that in order to simplify the presentation of the disclosure of the present disclosure, and thereby aiding in the understanding of one or more embodiments of the present disclosure, the foregoing descriptions of embodiments of the present disclosure sometimes group multiple features together in a single embodiment, accompanying drawings, or in a description thereof. However, this method of disclosure does not imply that the objects of the present disclosure require more features than those mentioned in the claims. Rather, claimed subject matter may lie in less than all features of a single foregoing disclosed embodiment.

Some embodiments use numbers to describe the number of components, attributes, and it should be understood that such numbers used in the description of the embodiments are modified in some embodiments by the modifiers “about,” “approximately,” or “substantially.” Unless otherwise noted, the terms “about,” “approximate,” or “substantially” indicates that a ±20% variation in the stated number is allowed. Correspondingly, in some embodiments, the numerical parameters used in the present disclosure and the claims are approximations, which varies depending on the desired features of individual embodiments. In some embodiments, the numerical parameters may take into account the specified number of significant digits and employ a general place-keeping. While the numerical domains and parameters used to confirm the breadth of their ranges in some embodiments of the present disclosure are approximations, in specific embodiments, such values are set to be as precise as possible within a feasible range.

For each of the patents, patent applications, patent application disclosures, and other materials cited in the present disclosure, such as articles, books, specification sheets, publications, documents, or the like., the entire contents of which are hereby incorporated herein by reference. Application history documents that are inconsistent with or conflict with the contents of the present disclosure are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and those set forth herein, the descriptions, definitions and/or use of terms in the present disclosure shall prevail.

Finally, it may be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A method for safety control of gas pressure regulator cabinet based on regulatory Internet of Things (IoT) performed based on a gas company management platform of a system for safety control of gas pressure regulator cabinet based on the regulatory IoT, wherein the method comprises:
determining accident warning information based on light data, air data, and inspection information, sending the accident warning information to a government safety regulatory management platform, and obtaining feedback information from the government safety regulatory management platform; and
determining a power use strategy based on power supply information, power storage module information, and power use information of at least one gas pressure regulator cabinet, and sending the power use strategy to the at least one gas pressure regulator cabinet through a gas company sensor network platform.

2. The method of claim 1, wherein the accident warning information includes a possible accident and a corresponding probability of the possible accident.

3. The method of claim 1, wherein the feedback information is determined by the government safety regulatory management platform based on the accident warning information within a preset time.

4. The method of claim 1, wherein the at least one gas pressure regulator cabinet includes a plurality of functional modules; and the power use strategy includes opening and closing conditions and opening and closing time nodes of the plurality of functional modules.

5. The method of claim 1, wherein the determining accident warning information based on the light data, the air data, and the inspection information includes:
determining a weatherability of the at least one gas pressure regulator cabinet to environment based on the inspection information; and
determining the accident warning information based on the light data, the air data, and the weatherability of the at least one gas pressure regulator cabinet to the environment.

6. The method of claim 5, wherein the method further includes:
determining, based on the inspection information, the weatherability of the at least one gas pressure regulator cabinet to the environment through a preset algorithm.

7. The method of claim 5, wherein the accident warning information is related to environmental data obtained based on a government regulatory sensor network platform;
the determining the accident warning information based on the light data, the air data, and the weatherability of the at least one gas pressure regulator cabinet to the environment further includes:
determining a first risk factor and a second risk factor based on the light data, the air data, and the environmental data; the first risk factor and the second risk factor reflecting a risk situation of the at least one gas pressure regulator cabinet; and
determining the accident warning information based on the first risk factor, the second risk factor, and the weatherability of the at least one gas pressure regulator cabinet to the environment.

8. The method of claim 7, wherein the method further includes:
determining, based on the light data, the air data, and the environmental data, the first risk factor and the second risk factor through a risk factor determination model; the risk factor determination model being a machine learning model.

9. The method of claim 7, wherein the accident warning information includes accident warning information for a foreseeable future, the accident warning information for the foreseeable future being related to a weather situation for the foreseeable future;
the determining the accident warning information based on the first risk factor, the second risk factor, and the weatherability of the at least one gas pressure regulator cabinet to the environment includes:
determine the accident warning information based on the first risk factor, the second risk factor, the weatherability of the at least one gas pressure regulator cabinet to the environment, and the weather situation for the foreseeable future.

10. The method of claim 9, wherein the method further includes:
determining, based on the first risk factor, the second risk factor, the weatherability of the at least one gas pressure regulator cabinet to the environment, and the weather situation for the foreseeable future, the accident warning information through a prediction model; the prediction model being a machine learning model.

11. The method of claim 1, wherein the determining a power use strategy based on power supply information, power storage module information, and the power use information of at least one gas pressure regulator cabinet includes:
determining a must-be-opened module set based on a module functional importance and the power supply information; and
determining the power use strategy based on the power use information of the at least one gas pressure regulator cabinet, the must-be-opened module set, the power storage module information, and the module functional importance.

12. The method of claim 11, wherein the at least one gas pressure regulator cabinet includes a plurality of functional modules; and the determining the must-be-opened module set based on the module functional importance and the power supply information includes:
determining a must-be-opened module by evaluating the plurality of functional modules based on the module functional importance and the power supply information; and
generating the must-be-opened module set based on the must-be-opened module.

13. The method of claim 11, wherein the method further includes:
determining, based on the power use information of the at least one gas pressure regulator cabinet, the must-be-opened module set, the power storage module information, and the module functional importance, the power use strategy through a power use strategy determination model; the power use strategy determination model being a machine learning model.

14. The method of claim 11, wherein the method further includes:
determining a necessary module based on the power use strategy and the must-be-opened module set; and
in response to a presence of the accident warning information, supplying power to the necessary module only.

15. A system for safety control of gas pressure regulator cabinet based on regulatory Internet of Things (IoT), wherein the system includes a government safety regulatory service platform, a government safety regulatory management platform, a government safety regulatory sensor network platform, a gas company management platform, a gas company sensor network platform, and a gas device object platform sequentially interacted with each other; the gas device object platform includes at least one gas pressure regulator cabinet;
the gas company management platform is configured to:
determine accident warning information based on light data, air data, and inspection information, send the accident warning information to the government safety regulatory management platform, and obtain feedback information from the government safety regulatory management platform; and
determine a power use strategy based on power supply information, power storage module information, and power use information of at least one gas pressure regulator cabinet, and send the power use strategy to the at least one gas pressure regulator cabinet through the gas company sensor network platform.

16. The system of claim 15, wherein the gas company management platform is further configured to:
determine a weatherability of the at least one gas pressure regulator cabinet to environment based on the inspection information; and
determine the accident warning information based on the light data, the air data, and the weatherability of the at least one gas pressure regulator cabinet to the environment.

17. The system of claim 16, wherein the accident warning information is related to environmental data obtained based on the government safety regulatory sensor network platform;
the gas company management platform is further configured to:
determine a first risk factor and a second risk factor based on the light data, the air data, and the environmental data; the first risk factor and the second risk factor reflecting a risk situation of the at least one gas pressure regulator cabinet; and
determine the accident warning information based on the first risk factor, the second risk factor, and the weatherability of the at least one gas pressure regulator cabinet to the environment.

18. The system of claim 15, wherein the gas company management platform is further configured to:
determine a must-be-opened module set based on a module functional importance and the power supply information; and
determine the power use strategy based on the power use information of the at least one gas pressure regulator cabinet, the must-be-opened module set, the power storage module information, and the module functional importance.

19. The system of claim 15, wherein the at least one gas pressure regulator cabinet includes a plurality of functional modules, the plurality of functional modules including a power storage module, a communication module, and a microprocessor; the microprocessor being configured to:
obtain the light data, the air data, the power storage module information, and the power use information of the at least one gas pressure regulator cabinet through the communication module, and transmit the light data, the air data, and the power use information of the at least one gas pressure regulator cabinet to the gas company management platform through the gas company sensor network platform; and
obtain the power use strategy from the gas company management platform through the gas company sensor network platform; in response to a power failure of a power supply line, the at least one gas pressure regulator cabinet switches to the power storage module for power supply based on the power use strategy, and shuts down or restarts at least one of the plurality of functional modules.

20. The system of claim 19, wherein the gas device object platform includes a light sensor module, a gas detection module and a distributed power detection module, the light sensor module disposed in the at least one gas pressure regulator cabinet.
